(19) United States
(12) Patent Application Publication
(10) Pub. No.: US 2025/0035920 A1
(43) Pub. Date: Jan. 30, 2025

(54) LASER PROCESSING UNIT AND IMAGING OPTICAL SYSTEM

(71) Applicant: ORC MANUFACTURING CO., LTD., Tokyo (JP)

(72) Inventor: Taishi SHIMIZU, Tokyo (JP)

(73) Assignee: ORC MANUFACTURING CO., LTD., Tokyo (JP)

(21) Appl. No.: 18/612,140

(22) Filed: Mar. 21, 2024

(30) Foreign Application Priority Data
Jul. 27, 2023 (JP) 2023-122619

(51) Int. Cl. G02B 26/12

(52) U.S. Cl. CPC G02B 26/124; G02B 26/121; G02B 26/125

(57) ABSTRACT

A laser processing unit according to the present invention includes a line-beam forming optical system configured to form a line-shaped laser beam from a laser beam with luminous flux, an imaging optical system configured to form the line-shaped laser beam on an object to be processed via a mask, a one-direction variable magnification optical unit including a concave cylindrical lens and a convex cylindrical lens, and a scanning mechanism. The concave cylindrical lens and the convex cylindrical lens are arranged along an optical axis and opposite to one another. A distance between the concave cylindrical lens and the convex cylindrical lens is changeable in order to change an imaging magnification of the imaging optical system in at least one direction.

### BACKGROUND OF THE INVENTION

### 1. Field of the Invention

The present invention relates to a laser processing unit or a laser machining process applied to an object such as a substrate with high energy density, and especially in the correction of an image projected on a substrate in accordance to a deformation of the substrate.

### 2. Description of the Related Art

Recently, an accurately formed pattern has been required for printed wiring boards, multilayer substrates such as a PKG substrate, and so on to achieve a fine pattern and a high-density mounting to a semiconductor. US 2021/0046584A1 discloses a laser ablation (also called photoablation) that is one processing method for forming a fine via hole or groove (trench). In the laser ablation, a laser beam with high energy density is formed in a line (not a point) by an optical lens such as a cylindrical lens. A scanner mechanism scans the line-shaped laser beam relative to a fixed mask or reticle to project an image in a line on a substrate or the like. By removing material from a surface of the substrate instantaneously, a via hole or trench is formed on the substrate.

As a laser beam with high energy density irradiates a substrate, the substrate deforms by heat and expands and/or contracts during laser processing. The direction and magnitude of expansion and/or contraction is influenced by the laser processing method and the pre- and post-processing, etc., and varies with the area of the substrate, but is not related to the scanning direction of the laser beam.

Therefore, it is necessary to precisely correct a line-shaped image projected on a substrate in accordance to an expansion and contraction of the substrate.

### SUMMARY OF THE INVENTION

A laser processing unit according to the present invention includes a line-beam forming optical system configured to form a line-shaped laser beam from a laser an beam with luminous flux, imaging optical system configured to form the line-shaped laser beam onto an object to be processed via a mask, a one-direction variable magnification optical unit including a concave cylindrical lens and a convex cylindrical lens, and a scanning mechanism. The concave cylindrical lens and the convex cylindrical lens are arranged along an optical axis and opposite to one another. The scanning mechanism is configured to scan the line-beam relative to the mask, the one-direction variable magnification optical unit, and the imaging optical system. The distance between the concave cylindrical lens and the convex cylindrical lens is changeable in order to change the imaging magnification of the imaging optical system in at least one direction.

An imaging optical system according to the present invention is provided in a laser processing unit. The laser processing unit scans a line-shaped laser beam relative to a mask and an object to be processed. The imaging optical system includes a one-direction variable magnification optical unit including a concave cylindrical lens and a convex cylindrical lens. The concave cylindrical lens and the convex cylindrical lens is arranged along an optical axis and opposite to one another. The line-shaped laser beam passing through the one-direction variable magnification optical unit. The laser processing unit includes further an actuator configured to change an imaging magnification of the imaging optical system in at least one direction by changing a distance between the concave cylindrical lens and the convex cylindrical lens.

### BRIEF DESCRIPTION OF THE DRAWINGS

The present invention will be better understood from the description of the preferred embodiment of the invention set forth below together with the accompanying drawings, in which:

FIG. 1 is a schematic view showing a laser processing unit according to a first embodiment.

FIG. 2 is a schematic block diagram of the laser processing unit;

FIG. 3 is a schematic perspective view of a one-direction variable magnification optical unit;

FIG. 4A is a cross-sectional view of the one-direction variable magnification optical unit on the Y-Z plane;

FIG. 4B is a cross-sectional view of the one-direction variable magnification optical unit on the X-Z plane;

FIG. 5 is a view showing a corrected image according to the one-direction variable magnification optical unit;

FIG. 6 is a view showing a corrected image according to the one-direction variable magnification optical unit and an isotropic variable magnification optical unit; and

FIG. 7 is a schematic view of a one-direction variable magnification optical unit according to a second embodiment.

### DESCRIPTION OF THE PREFERRED EMBODIMENTS

Hereinafter, the preferred embodiment of the present invention is described with references to the attached drawings.

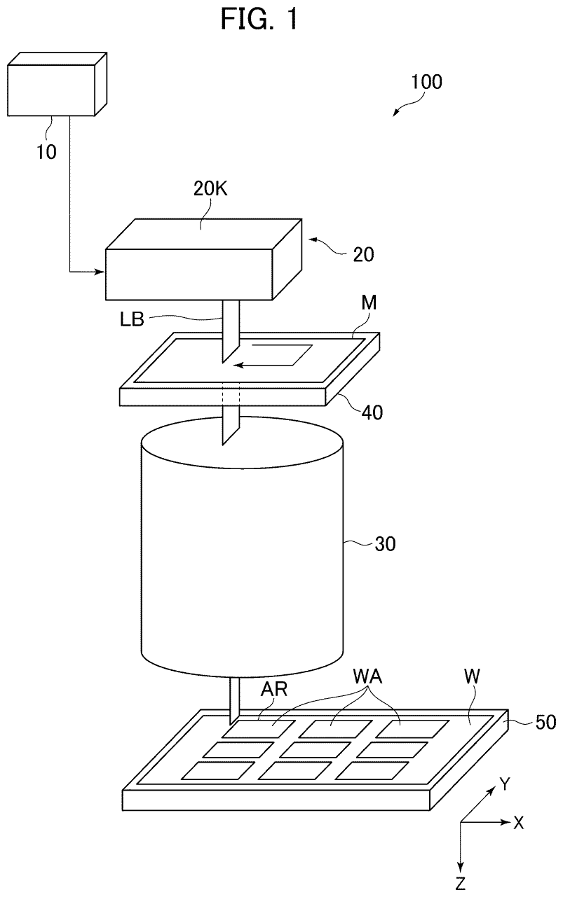

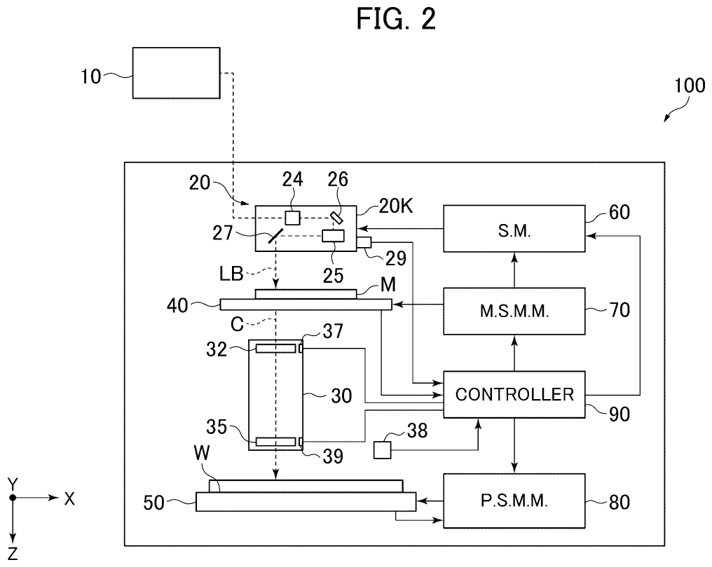

FIG. 1 is a schematic view showing a laser processing unit according to the first embodiment. FIG. 2 is the schematic block diagram of the laser processing unit.

A laser processing unit 100, which forms a pattern on a substrate W by laser ablation, is equipped with an optical device 20, an imaging optical system 30, a mask stage 40 and a processing stage 50. The optical device 20, the imaging optical system 30 and the processing stage 50 are attached to a base (not shown) and movable with respect to the base, respectively.

A mask M and the substrate W are placed on the mask stage 40 and the processing stage 50, respectively. The substrate W is herein a resin substrate such as a printed wiring board.

A laser 10 is arranged adjacent to the base and oscillates a laser beam with high energy density. Herein, the laser 10 is an excimer laser that emits a KrF excimer laser beam with the wavelength of 248 nm per pulse. An oscillated laser beam is directed to the optical device 20 via a correction optical system (not shown) for adjusting an optical axis. The laser 10 may or may not be incorporated into the laser processing unit 10.

The optical device 20 is equipped with a lens array 24, a line-beam forming optical system 25 including a cylindrical lens, an angle switching mirror 26, etc., which are contained in a casing 20K. The lens array 24 adjusts the distribution of the intensity of the laser beam. The line-beam forming optical system 25 forms a line-shaped laser beam LB from the laser beam with luminous flux.

The casing 20K is supported by a scanning mechanism 60 shown in FIG. 2. The scanning mechanism 60 moves the optical device 20 along the main-scanning direction at a given speed. The line-shaped laser beam LB moves relative to the mask M along the scanning direction. Herein, the X axis and Y axis are defined along the main-scanning direction and the sub-scanning direction, respectively.

The angle switching mirror 26 switches a mirror angle to shift the position of the laser beam LB irradiating the mask M along the sub-scanning direction (the Y axis direction), i.e., switches an irradiation area on the mask M. Herein, the angle switching mirror 26 is arranged at a conjugate point that is between the lens array 24 and the line-beam forming optical system 25.

The mask stage 40 supports the mask M and moves the mask M along the main-scanning direction (the X-axis direction) and the sub-scanning direction (the Y-axis direction). The mask stage 40 may rotate the mask M. A mask stage moving mechanism 70 drives the mask stage 40 based on signals output from a position detecting sensor (not shown).

The Mask M is composed of a rectangular base material that transmits a KrF excimer laser beam, such as quartz glass. A shading film such as aluminum film is further formed on an area that surrounds the mask pattern. For example, a mask pattern for forming an interstitial via hole on the substrate W is formed on the Mask.

The imaging optical system (projection optical system) 30 has focus points on the surfaces of the mask M and the substrate W. The line-shaped laser beam (hereinafter, also called “line-beam”) LB passes through the mask M and enters the imaging optical system 30 as a light pattern. The imaging optical system 30 focuses the line-beam on the surface of the substrate W. Herein, the imaging optical system 30 is a reduced-lens optical system, which has a projection magnification less than 1 (e.g., 0.5).

The processing stage 50 fixes the substrate W by a vacuum adsorption process and moves the substrate W along the main-scanning direction (the X-axis direction) and the sub-scanning direction (the Y-axis direction). The processing stage 50 may rotate the mask M. A processing-stage moving mechanism 80 drives the processing stage 50 based on signals output from a position-detecting sensor (not shown).

In the substrate W, a copper wiring layer is formed on an epoxy resin and an insulation layer is further formed on the copper wiring layer. As described above, the laser 10 emits the excimer laser beams with high energy density towards the substrate W, which ablates, i.e., removes material from W that the substrate SO a pattern corresponding to a mask pattern (hereinafter, “processing pattern”) WA is formed on the substrate W. For example, an interstitial via hole, blind via hole, wiring groove (trench), etc., can be formed on the substrate W.

While the optical device 20 moves in the main-scanning direction (the X-axis direction), the line-beam LB parallel to the sub-scanning direction (the Y-axis direction) moves relative to the mask stage 40 (mask M), the imaging optical system 30, and the processing stage 50 (the substrate W). Namely, the optical device 20 scans the mask M and the substrate W with the line-shaped laser beam LB. Herein, the processing pattern WA is formed repeatedly on each processed area AR of the substrate W shown in FIG. 1. The mask pattern on the mask M corresponds to the processing pattern WA.

The mask patten MA is based on the size of the processed area AR of the substrate W and an imaging magnification by the imaging optical system 30. The width of the line-beam LB along the Y-axis direction is smaller than that of the mask pattern MA. The scanning along the X-axis direction is repeatedly carried out on the mask M as the angle-switching mirror 26 switches the irradiated the LB along the Y-axis position of line-beam direction. Thus, the entire processing pattern WA is formed in one processed area AR.

The processing stage 50 moves step by step along the main-scanning direction (the X-axis direction) and the sub-scanning direction (the Y-axis direction) wherever the processing pattern WA is formed on each processed area AR to carry out the laser ablation process on the next processed area AR. After the laser ablation process for the substrate W is finished, the substrate W is filled with a conductor such as copper. Note that a mask pattern MA corresponding to the total area of the substrate W may be formed on the mask M.

A controller 90 controls the angle-switching mirror 26 in the optical device 20, the scanning mechanism 60, the mask stage moving mechanism 70 and the processing stage moving mechanism 80, etc., to control the laser ablation process. Concretely, the controller 90 positions the mask M and the substrate W, moves the irradiated position of the line-beam LB along the main-scanning direction (the X-axis direction), and shifts the irradiated position along the sub-scanning direction (the Y-axis direction).

The imaging optical system 30 includes a one-direction variable magnification optical unit 32 and an isotropic variable magnification optical unit 35. The one-direction variable magnification optical unit 32 is arranged closest to the mask M, whereas the isotropic variable magnification optical unit 35 is arranged closest to the substrate W.

Note that the arrangement of the one-direction variable magnification optical unit 32 and the isotropic variable magnification optical unit 35 may be interchangeable. Also, the one-direction variable magnification optical unit 32 and the isotropic variable magnification optical unit 35 may be arranged in the lens group within the imaging optical system 30, or outside the imaging optical system 30.

The one-direction variable magnification optical unit 32 allows the imaging magnification of the imaging optical system 30 to change and adjust along one direction. Herein, the imaging magnification is changeable along the sub-scanning direction (the Y-axis direction). An image of the line-beam LB focused on the substrate W is corrected by changing the magnification in one direction.

On the other hand, the isotropic variable magnification optical unit 35 allows the imaging magnification of the imaging optical system 30 to change and adjust while maintaining the scale of a projected image on the X-Y plane. An image of the line-beam LB focused on the substrate W is corrected by changing the magnification isotropically, i.e., in any direction on the X-Y plane.

An alignment camera 29 is attached to the casing 20K of the optical device 20 and captures alignment marks formed on the mask M. Another alignment camera 38 is arranged adjacent to the processing stage 50 and captures alignment marks formed on the substrate W. The alignment cameras 29 and 38 capture alignment marks formed on the mask M and substrate W (e.g., alignment marks formed on four corners of the mask M and the substrate W) when the mask stage 40 and the processing stage 50 move along the X direction and the Y direction, respectively.

The controller 90 detects displacements of the alignment marks from (e.g., standard positions predetermined design positions) using image data obtained by the alignment cameras 29 and 38. The controller 90 then calculates amounts of expansion and/or contraction along the X direction and the Y direction. Note that the controller 90 may detect an amount of misalignment around the Z direction perpendicular to the X-Y plane as an amount of rotation. In this case, the controller 90 calculates amounts of expansion and/or contraction along the X direction and the Y direction in addition to the amount of rotation. Since the measurement of amounts of expansion and/or contraction in the substrate W is well known, a detailed explanation is herein omitted.

An actuator 37 and another actuator 39 drive the one-direction variable magnification optical unit 32 and the isotropic variable magnification optical unit 35 along the optical axis, respectively. The controller 90 controls the actuators 37 and 39 based on the measured amounts of expansion and/or contraction along the X direction and the Y direction to correct the image of the line-beam LB formed on the substrate W. Concretely, the controller 90 corrects positions of the one-direction variable magnification optical unit 32 and the isotropic variable magnification optical unit 35 along the optical axis C, respectively, to project an image of the line-beam LB on the substrate W at a predetermined magnification.

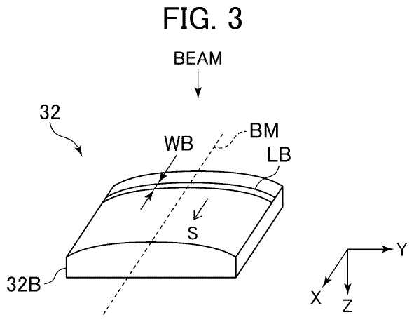

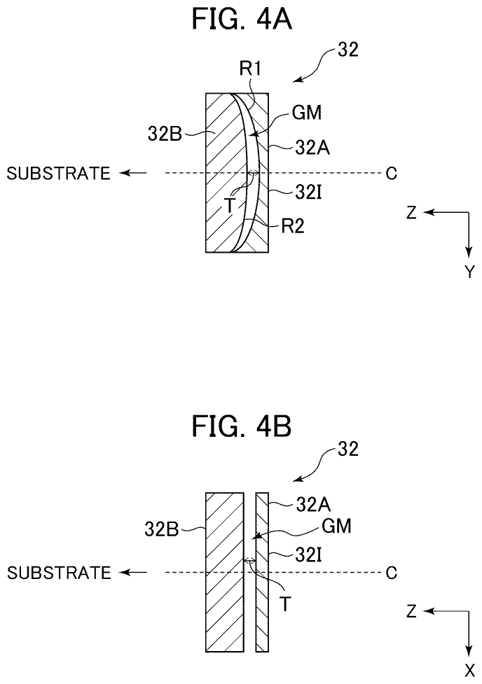

FIG. 3 is the schematic perspective view of the one-direction variable magnification optical unit 32. FIG. 4A is the cross-sectional view of the one-direction variable magnification optical unit 32 on the Y-Z plane. FIG. 4B is the cross-sectional view of the one-direction variable magnification optical unit 32 on the X-Z plane. Herein, the main scanning direction is designated as “S”.

The one-direction variable magnification optical unit 32 is constructed of a concave cylindrical lens 32A and a convex cylindrical lens 32B opposite to one another. Note that FIG. 3 shows only the convex cylindrical optical lens 32B.

As shown in FIGS. 4A and 4B, the concave cylindrical lens 32A and the convex cylindrical lens 32B are square-shaped lenses, respectively, and their opposing surfaces are parallel to a direction perpendicular to the optical axis C.

The line-shaped laser beam LB moves relative to the concave cylindrical lens 32A and the convex cylindrical lens 32B as the scanning mechanism 60 moves the optical device 20 along the main-scanning direction S (the X-axis direction). The one-direction variable magnification optical unit 32 has a size that allows the line-shaped laser beam LB to pass through the incident surface 32I along the main-scanning direction S. The size also depends upon the width WB of line beam LB, energy density required for the laser ablation, the scanning speed, etc.

The orientation of the one-direction variable magnification optical unit 32 depends upon the direction of a generatrix BM. Herein, the one-direction variable magnification optical unit 32 is placed such that the direction of the generatrix BM is aligned with the main scanning direction S. The longitudinal direction of the line-beam LB corresponds to a curved direction, i.e., a direction perpendicular to the main-scanning direction S.

As shown in FIG. 4A, the curvature R1 of the concave cylindrical lens 32A is different from the curvature R2 of the convex cylindrical lens 32B. There is a gap or space GM in the state where the concave cylindrical lens 32A approaches and makes contact with the convex cylindrical lens 32B. The curvatures R1 and R2 are predetermined so that the entire opposing curved surfaces of the concave and convex cylindrical lenses 32A and 32B are not in close contact. Note that the curvatures R1 and R2 may be the same in a situation where the concave and convex cylindrical lenses 32A and 32B are in close contact.

The concave cylindrical lens 32A is supported by a frame (not shown) and the convex cylindrical lens 32B is also supported by a frame (not shown). Herein, the convex cylindrical lens 32B is movable along the optical axis C. The actuator 37 drives the convex cylindrical lens 32B via the frame. The actuator 37 is constructed of a motor and a cam mechanism, for example.

The controller 90 controls the actuator 37 based on measured amounts of expansion or contraction along the Y direction to adjust an interval T between the concave cylindrical lens 32A and the convex cylindrical lens 32B. As described above, the one-direction variable magnification optical unit 32 corrects an imaging magnification in one direction, i.e., the Y direction. The interval T is adjusted to enlarge or reduce the imaging magnification.

When the interval T is longer than a standard or base interval TO, the imaging magnification is enlarged. When the interval T is shorter than the standard interval TO, the imaging magnification is reduced.

Note that the position relationship between the concave cylindrical lens 32A and the convex cylindrical lens 32B along the optical axis C may be reversed. The convex cylindrical lens 32B may move along the optical axis C instead of the concave cylindrical lens 32A. Both the concave cylindrical lens 32A and the convex cylindrical lens 32B may move along the optical axis C.

The isotropic variable magnification optical unit 35 shown in FIG. 2 is herein constructed of a single circular lens (e.g., a plano-convex lens or double convex lens). The actuator 39 moves the isotropic variable magnification optical unit 35 along the optical axis C, which allows the imaging magnification to be enlarged or reduced isotropically, i. e., in any direction on the X-Y plane. Note that the isotropic variable magnification optical unit 35 may comprise multiple lenses such as a focusing lens unit.

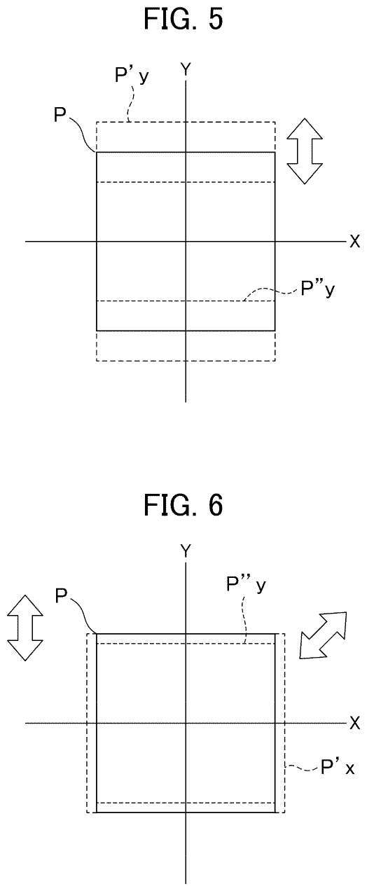

FIG. 5 is the view showing a corrected image according to the one-direction variable magnification optical unit 32. FIG. 6 is a view showing a corrected image according to the one-direction variable magnification optical unit and the isotropic variable magnification optical unit 35.

As described above, the one-direction variable magnification optical unit 32 enlarges or reduces a projected image P on the substrate W in the Y-axis direction. In FIG. 5, an enlarged image is designated as P′y and an reduced image is designated as P″y. Since a refractive index along the generatrix BM is constant (see FIG. 3), the imaging magnification of the projected image P along the X direction is uniform or constant during the scanning of the line-beam LB, regardless of the change in interval T.

In FIG. 6, a projected image is corrected along the X-axis direction by a combination of the one-direction variable magnification optical unit 32 and the isotropic variable magnification optical unit 35. The one-direction variable magnification optical unit 32 reduces an image P of the line-beam LB along the Y-axis direction by a predetermined magnification (<1) and the isotropic variable magnification optical unit 35 enlarges the reduced image P″y isotropically by a predetermined magnification (>1). Thus, an image P′x that is enlarged along the X-axis direction is formed on the substrate W.

The combination of the one-direction variable magnification optical unit 32 and the isotropic variable magnification optical unit 35 allows a projected image to be enlarged or reduced along both the X-axis and Y-axis directions. The controller 90 adjusts the interval T in accordance to the measured amounts of expansion and/or contraction of the substrate W so that a projected image P is formed on the substrate W with a desirable and predetermined magnification.

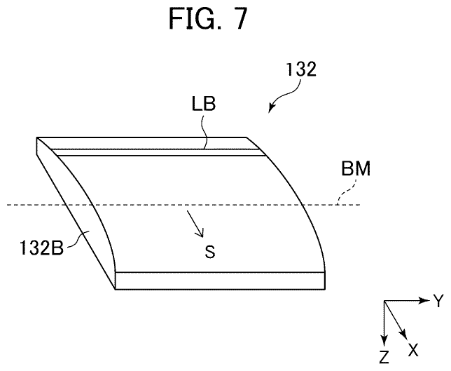

With reference to FIG. 7, the second embodiment is explained. FIG. 7 is the schematic view of a one-direction variable magnification optical unit according to a second embodiment.

A one-direction variable magnification optical unit 132 is constructed of a concave cylindrical lens (not shown) and a convex cylindrical lens 132B. The one-direction variable magnification optical unit 132 is placed so that the generatrix BM is aligned in a direction perpendicular to the main-scanning direction S, i.e., the longitudinal direction of the line-beam LB. Accordingly, the thickness of the two cylindrical lenses along the longitudinal direction of the line-beam LB is uniform, i.e., a the refractive index along the sub-scanning direction (the Y-axis direction) is constant.

The one-direction variable magnification optical unit 132 enlarges or reduces a projected image along the X direction, which is different from the first embodiment. The convex cylindrical lens 132B is movable along the optical axis C and an interval between the concave cylindrical lens and the convex cylindrical lens 132B is adjusted to enlarge or reduce the imaging magnification, similarly to the first embodiment. The imaging magnification along the X direction is marginally or slightly adjusted by changing the position of the convex cylindrical lens 132B during the scanning of the line-beam LB.

For example, a projected image is slightly enlarged or reduced along the X direction in accordance to the scanning position in each processing area AR by adjusting the imaging magnification in detail. In this case, multiple alignment marks are formed on each processing area AR. Furthermore, by combination of the isotropic variable magnification optical unit, a projected image can be enlarged or reduced along both the X and Y directions in accordance to a desirable magnification, similarly to the first embodiment.

In the first embodiment and the second embodiments, only a single one-direction variable magnification optical unit is arranged. However, the above two one-direction variable magnification optical units may be arranged in the imaging optical system 30. In this case, one optical unit is selectively arranged on the optical axis S, whereas the other optical unit is arranged outside the optical axis C.

The actuator 37 may rotate the one-direction variable magnification optical unit 32 around the optical axis C. In this case, the orientation of the one-direction variable magnification optical unit 32 can be selectively switched by rotating the one-direction variable magnification optical unit 32 by 90 degrees, in accordance to the magnitude of expansion and contraction of the substrate W.

The orientation of the one-direction variable magnification optical unit 32 (132) may be inclined to the main-scanning direction (the X-axis direction) or the sub-scanning direction (the Y-axis direction) by rotating the one-direction variable magnification optical unit 32. Then, by the rotation of the one-direction variable magnification optical unit 32, the orientation of the one-direction variable magnification optical unit 32 can be changed to a desirable direction and switched at a desirable timing during the scanning of the line-beam LB.

For example, the one-direction variable magnification optical unit is positioned as shown in the first embodiment or as shown in the second embodiment when starting the scanning of the line-beam LB, and is rotated to a determined direction on the way. Afterward, the one-direction variable magnification optical unit is rotated to the original position. This allows the imaging magnification to be adjusted in accordance to amount of expansion and contraction corresponding to the scanning position of the line-beam LB as the line-beam LB passes through the optical surface of the one-direction variable magnification optical unit.

On the other hand, when starting the scanning, the one-direction variable magnification optical unit 32 may be positioned such that the orientation of the one-direction variable magnification optical unit 32 (132) is inclined at an angle with respect to the main-scanning direction (the X-axis direction) or the sub-scanning direction (the Y-axis direction). For example, the one-direction variable magnification optical unit 32 is rotated such that the generatrix BM is aligned with the X direction or the Y direction on the way, but returns to the original position afterward.

In this way, the laser processing unit explained above is equipped with the one-direction variable magnification optical unit with the concave and convex cylindrical lenses that are opposite one another. In the laser ablation process, the optical unit transmits the line-beam LB and the line-beam LB passes through the optical surface of the optical unit. The one-direction variable magnification optical unit is positioned so that the generatrix BM is aligned in a given direction. Thus, the direction of magnification for a projected image can be defined arbitrarily. This enables a proper correction of a projected image to a complicated deformation of the substrate W.

In the laser ablation process, the line-beam LB passes through the one-direction variable magnification optical unit 32 instead of being concentrated on a local irradiated area, thus distributing the laser-beam energy absorbed by the optical unit 32, which extends the lifetime of the optical unit 32. Furthermore, since heat caused by light absorption is also distributed, deformation of the lens characteristics is suppressed.

As described above, a gap or space GM exists between the concave cylindrical lens and the convex cylindrical lens. Thus, stress is relieved between the two lenses when the distribution of heat and expansion rate changes, which prevents damage or corruption of the lenses.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Application No. 2023-122619 (filed on Jul. 27, 2023), which is expressly incorporated herein by reference, in its entirety.

1. A laser processing unit comprising:
a line-beam forming optical system configured to form a line-shaped laser beam from a laser beam with luminous flux;
an imaging optical system configured to form the line-shaped laser beam on an object to be processed via a mask;
a one-direction variable magnification optical unit including a concave cylindrical lens and a convex cylindrical lens, said concave cylindrical lens and said convex cylindrical lens being arranged along an optical axis and opposite to one another; and
a scanning mechanism configured to scan the line-beam relative to said mask, said one-direction variable magnification optical unit and said imaging optical system,
a distance between said concave cylindrical lens and said convex cylindrical lens being changeable in order to change an imaging magnification of said imaging optical system in at least one direction.

2. The laser processing unit according to claim 1, wherein further comprising an isotropic variable magnification optical unit with one lens or a plurality of lenses, said isotropic variable magnification optical unit arranged along the optical axis to change the imaging magnification isotropically.

3. The laser processing unit according to claim 1, wherein said one-direction variable magnification optical unit is closer to said mask than said isotropic variable magnification optical unit.

4. The laser processing unit according to claim 3, wherein the distance is changeable during the scanning of the line-beam.

5. The laser processing unit according to claim 1, wherein a curvature of said concave cylindrical lens is different from a curvature of said convex cylindrical lens.

6. The laser processing unit according to claim 1, wherein the generatrix of said one-direction variable magnification optical unit is along a scanning direction of the line-beam.

7. The laser processing unit according to claim 1, wherein the generatrix of said one-direction variable magnification optical unit is along a direction perpendicular to a scanning direction of the line-beam.

8. The laser processing unit according to claim 1, wherein the generatrix of said one-direction variable magnification optical unit is inclined to a scanning direction of the line-beam.

9. The laser processing unit according to claim 1, wherein further comprising an actuator configured to rotate said one-direction variable magnification optical unit around the optical axis.

10. An imaging optical system provided in a laser processing unit, said laser processing unit scanning a line-shaped laser beam relative to a mask and an object to be processed, said imaging optical system comprising:
a one-direction variable magnification optical unit including a concave cylindrical lens and a convex cylindrical lens, said concave cylindrical lens and said convex cylindrical lens being arranged along an optical axis and opposite to one another, the line-shaped laser beam passing through said one-direction variable magnification optical unit; and
an actuator configured to change an imaging magnification of said imaging optical system in at least one direction by changing a distance between said concave cylindrical lens and said convex cylindrical lens.
